(19) United States
(12) Patent Application Publication
(10) Pub. No.: US 2019/0026795 A1
(43) Pub. Date: Jan. 24, 2019

(54) EVALUATION DEVICE AND EVALUATION METHOD

(71) Applicant: FUJITSU LIMITED, Kawasaki-shi (JP)

(72) Inventors: Azusa Kimura, Ota (JP); HIDEKAZU ARAI, Kawasaki (JP); SHUANG XU, Kawasaki (JP)

(73) Assignee: FUJITSU LIMITED, Kawasaki-shi (JP)

(21) Appl. No.: 16/030,229

(22) Filed: Jul. 9, 2018

(30) Foreign Application Priority Data
Jul. 18, 2017 (JP) 2017-138961

(51) Int. Cl. G06Q 30/02

(52) U.S. Cl. CPC G06Q 30/0283

(57) ABSTRACT

An evaluation device includes a memory, and a processor coupled to the memory and configured to receive an evaluation target cost-logic for a cost-logic defined with a calculation expression that calculates a cost of a service and a record including a combination of an item used in the calculation expression and a unit corresponding to the item, refer to a standard cost-logic stored in the memory in advance for each type of service, specify a difference for matching a first record of the evaluation target cost-logic with a second record of the standard cost-logic, the first record and the second record being for a same type of service, reflect the specified difference to the first record, and compare a first calculation expression of the evaluation target cost-logic using the first record and a second calculation expression of the standard cost-logic using the second record.

### CROSS-REFERENCE TO RELATED APPLICATION

This application is based upon and claims the benefit of priority of the prior Japanese Patent Application No. 2017-138961, filed on Jul. 18, 2017, the entire contents of which are incorporated herein by reference.

### FIELD

The embodiment discussed herein is related to an evaluation device and an evaluation method.

### BACKGROUND

When starting service operations such as a support desk and a data center, cost of the service operations is calculated based on work contents related to the service operations.

As a technology of determining work contents, for example, a system of collecting condition information related to a medical apparatus installed in a medical facility, and determining maintenance work contents of the medical apparatus based on the collected condition information is proposed. The system provides information on the determined maintenance work contents to a person in charge of the maintenance of the medical apparatus.

In addition, as a technology related to the cost calculation of services, for example, an operation design support system including an operation requirement data base (DB) for storing an operation work item, an operation requirement, and a service level, and a method of displaying the contents of the operation requirement DB on a screen and inputting a design item is proposed. The system also includes a data processing method for calculating the cost and creating a design document based on the input design item.

Japanese Laid-open Patent Publication No. 2005-122707 and Japanese Laid-open Patent Publication No. 2009-75961 are examples of the related art.

### SUMMARY

According to an aspect of the invention, an evaluation device includes a memory, and a processor coupled to the memory and the processor configured to receive an evaluation target cost logic for a cost logic defined with a calculation expression that calculates a cost of a service and a record including a combination of an item used in the calculation expression and a unit corresponding to the item, refer to a standard cost logic stored in the memory in advance for each type of service, specify a difference for matching a first record of the evaluation target cost logic with a second record of the standard cost logic, the first record and the second record being for a same type of service, reflect the specified difference to the first record, and compare a first calculation expression of the evaluation target cost logic using the first record and a second calculation expression of the standard cost logic using the second record.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram of an evaluation apparatus according to the present embodiment;

FIG. 2 is a diagram illustrating an example of an evaluation target cost logic;

FIG. 3 is a diagram illustrating an example of comparison results of cost items;

FIG. 4 is a table illustrating an example of a difference definition data base (DB);

FIG. 5 is a table illustrating an example of presenting a candidate of a difference definition;

FIG. 6 is a diagram illustrating an example of an input screen for receiving the difference definition;

FIG. 7 is a table for explaining storage of the difference definitions in the difference definition DB;

FIG. 8 is a diagram illustrating an example of a comparison result of a calculation expression;

FIG. 9 is a table illustrating an example of presenting a candidate of the difference definition;

FIG. 10 is a diagram for explaining storage of the difference definition in the difference definition DB;

FIG. 11 is a diagram illustrating an example of an evaluation result;

FIG. 12 is a block diagram illustrating a schematic configuration of a computer functioning as the evaluation apparatus according to the present embodiment;

FIG. 13 is a flowchart illustrating an example of evaluation processing in the present embodiment;

FIG. 14 is a flowchart illustrating an example of cost item difference specification processing;

FIG. 15 is a flowchart illustrating an example of calculation expression comparison processing; and

FIG. 16 is a flowchart illustrating an example of cost calculation processing.

### DESCRIPTION OF EMBODIMENT

In providing services to customers, a cost logic for service definition and cost calculation is created, and cost estimation and determination for service operation are performed in a country where the service is operated. In an operation of a certain service, in a case where a cost of the service operation is calculated in each country, since the cost logic is disunified in each country, there is a possibility that contradiction may arise in the cost calculation between countries.

In recent years, as globalization in services progresses, not only unification of service contents, but also homogenization of cost logic is desirable. For this reason, it is conceivable to use a unified cost logic for cost calculation of services operated globally. Since there are various views about services and costs and different business practices depending on countries, it is desirable to evaluate whether or not the unified cost logic is applicable in own country. However, because various factors are related to the cost calculation of services, it may take a lot of labor and time in some cases to properly compare and evaluate the unified cost logic and the cost logic of own country.

Hereinafter, an example of an embodiment according to a technology that makes it possible to properly and easily perform the evaluation related to the unification of the cost logic for calculating cost will be described with reference to the drawings. In the present embodiment, as an example, a case of evaluating to determine whether or not the unified cost logic for services provided in each country is acceptable in an evaluation target country (Germany (GE) in the present embodiment) will be explained as an assumed example. That is, the cost logic of the evaluation target country is referred to as an evaluation target cost logic, and is evaluated by comparing with the unified cost logic.

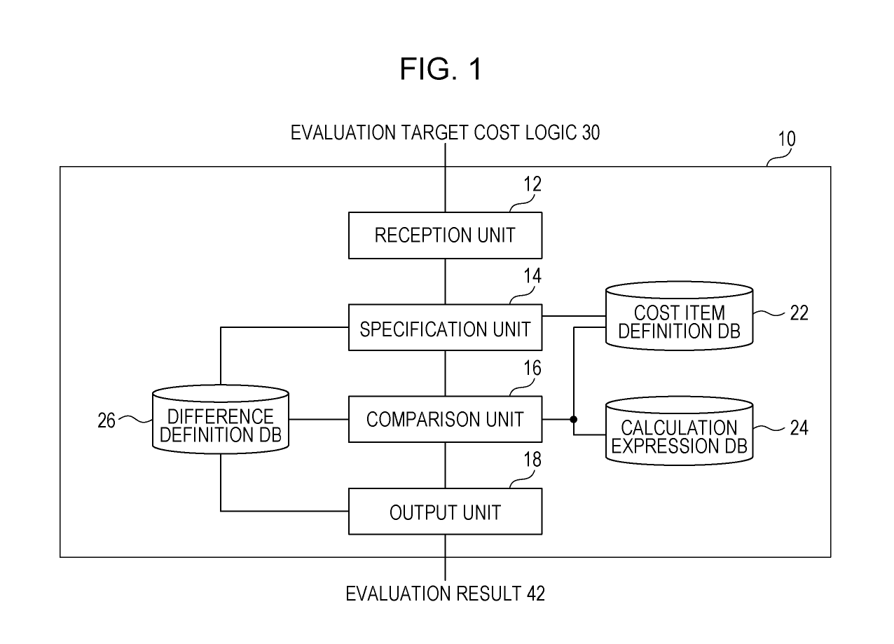

As illustrated in FIG. 1, an evaluation apparatus 10 according to the present embodiment receives an evaluation target cost logic 30 with an input and outputs an evaluation result 42 which compared the evaluation target cost logic 30 and a standard cost logic. The evaluation apparatus 10 functionally includes a reception unit 12, a specification unit 14, a comparison unit 16, and an output unit 18. Moreover, the reception unit 12 is an example of a reception unit of the embodiment, the specification unit 14 is an example of an extraction unit or a specification unit of the embodiment, and the comparison unit 16 is an example of a change unit or a comparison unit of the embodiment.

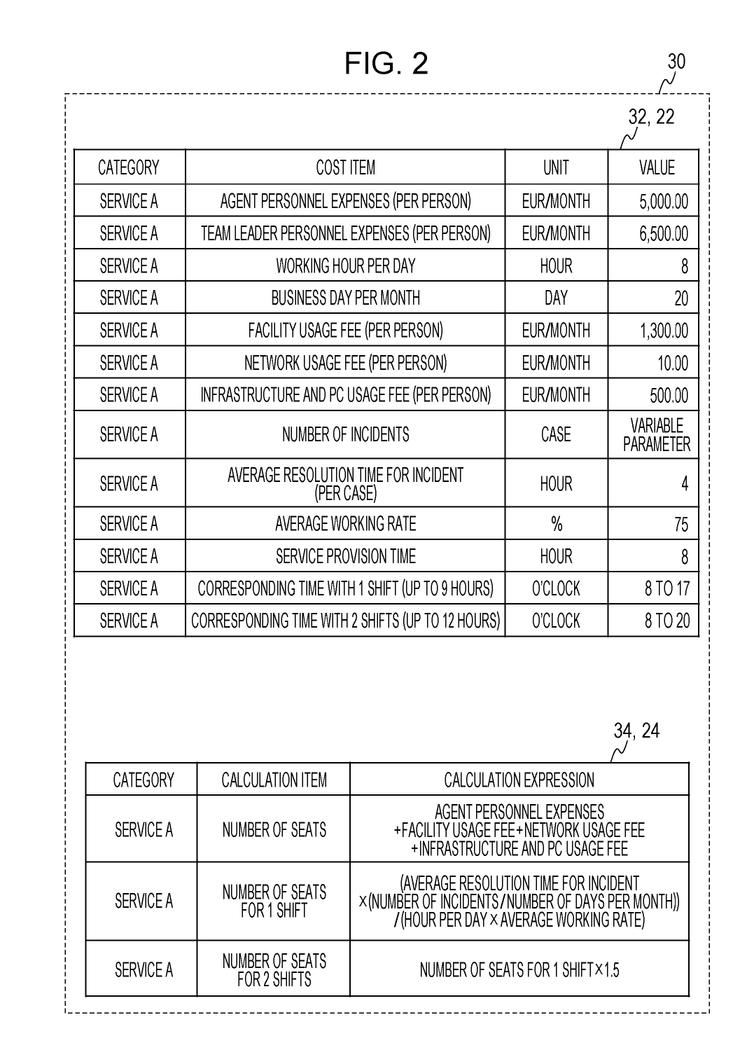

The reception unit 12 receives the evaluation target cost logic 30 input in the evaluation apparatus 10 and transfers the received evaluation target cost logic 30 to the comparison unit 16. The evaluation target cost logic 30 is defined by a cost item which is the minimum unit when comparing the cost logic, a unit corresponding to the cost item, and a calculation expression expressed using the cost item and the unit. For example, as illustrated in FIG. 2, the evaluation target cost logic 30 includes a cost item definition data base (DB) 32 and a calculation expression DB 34. A plurality of records in a combination of a “cost item” and a “unit” and a value substituted into the cost item when calculating cost are stored in the cost item definition DB 32. Moreover, a plurality of records in a combination of a “calculation item” for cost calculation of service operation and a “calculation expression” defined using the cost item for the calculation item are stored in the calculation expression DB 34.

Each record of the cost item definition DB 32 and the calculation expression DB 34 are associated with a category indicating the type of service targeted by the evaluation target cost logic 30. A service category (“service A” in the example of FIG. 2) is, for example, an operation of a support desk, an operation of a data center, and the like.

In a predetermined region of the evaluation apparatus 10, for each service category, each of the cost item definition DB 22 and the calculation expression DB 24 for defining the standard cost logic are stored. A standard cost logic is a unified cost logic in each country. The standard cost logic may be created based on cost logics of a plurality of countries or may be a cost logic of any representative country.

Each data structure of the cost item definition DB 22 and the calculation expression DB 24 of the standard cost logic is similar to each data structure of the cost item definition DB 32 and the calculation expression DB 34 illustrated in FIG. 2 except that the records on a plurality of categories are stored therein. Hereinafter, a record of the cost item definition DB 32 is referred to as an “evaluation target cost item”, a record of the cost item definition DB 22 is referred to as a “standard cost item”, a calculation expression of the calculation expression DB 34 is referred to as an “evaluation target calculation expression”, and a calculation expression of the calculation expression DB 24 is referred to as a “standard calculation expression”.

The specification unit 14 specifies a difference between the cost item definition DB 32 and the cost item definition DB 22. Specifically, the specification unit 14 extracts an evaluation target cost item that does not match the standard cost item associated with the same category as the service category of the evaluation target cost logic 30 among the standard cost items stored in the cost item definition DB 22. The specification unit 14 specifies a difference for matching the extracted evaluation target cost item with the corresponding standard cost item, and stores the specified difference in a difference definition DB 26.

More specifically, the specification unit 14 extracts a standard cost item in which “category” field of the cost item definition DB 22 is the same as “category” of the evaluation target cost item. The specification unit 14 compares the evaluation target cost item and the standard cost item by associating each evaluation target cost item and each extracted standard cost item on a one-to-one basis based on, for example, a degree of consistency of character strings.

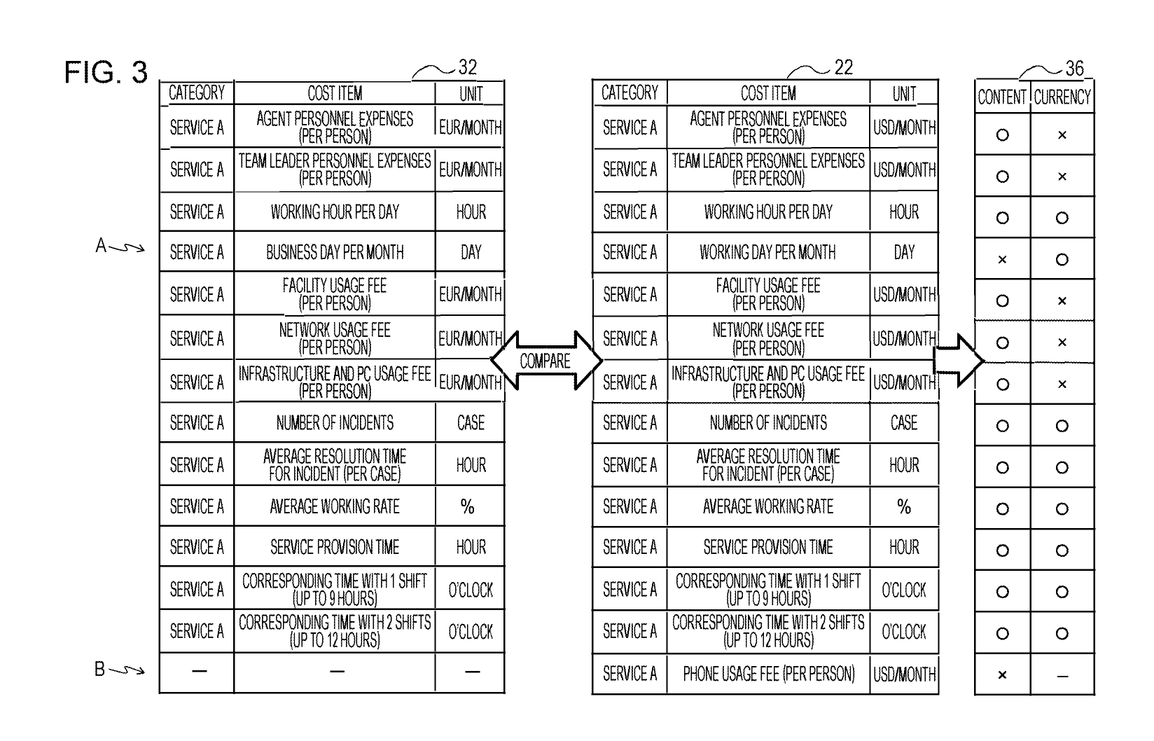

The specification unit 14 extracts an evaluation target cost item for which a “cost item” or a “unit” defined other than a currency is inconsistent with the standard cost item (hereinafter, referred to as “evaluation target cost item with content inconsistency”). The specification unit 14 also extracts an evaluation target cost item for which the currency defined in the “unit” in currency is inconsistent (hereinafter, referred to as “evaluation target cost item with currency inconsistency”). An example of a comparison result 36 between the evaluation target cost item and the standard cost item is illustrated in FIG. 3. Here, it means that an evaluation target cost item having an X mark in a “content” field of the comparison result 36 is extracted as the evaluation target cost item with content inconsistency, and an evaluation target cost item having an X mark in a “currency” field is extracted as the evaluation target cost item with currency inconsistency. An evaluation target cost item without any standard cost item comparable with the cost item definition DB 22 is referred to as the evaluation target cost item with content inconsistency. For a standard cost item without any evaluation target cost item comparable with the cost item definition DB 32, a provisional evaluation target cost item indicating that a “cost item” of the standard cost item is not present in the evaluation target cost item is created, and is referred to as the evaluation target cost item with content inconsistency.

The specification unit 14 presents a candidate of difference definition to a user for the extracted evaluation target cost item with content inconsistency. Difference definition means information indicating difference between an evaluation target cost logic and a standard cost logic, and here, means information for matching the evaluation target cost item that does not match the standard cost item with the standard cost item. That is, in a case where the difference definition is reflected to the evaluation target cost item with content inconsistency, the evaluation target cost item after the difference definition is reflected matches the standard cost item. Here, “match” includes not only the case where the character strings are perfectly consistent, but also a case of the evaluation target cost item and the standard cost item are synonymous.

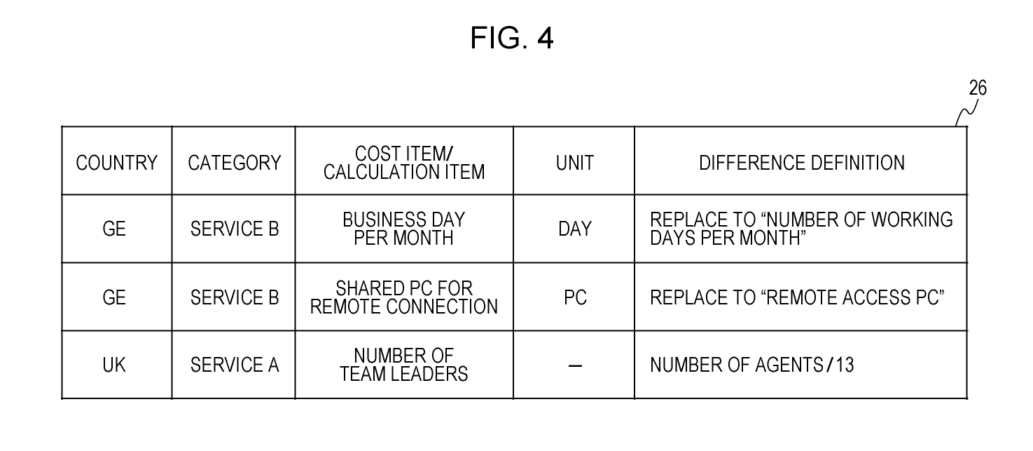

The specification unit 14 extracts the candidate of the difference definition from the difference definition DB 26. In the difference definition DB 26, as illustrated in FIG. 4, the difference definition specified when evaluating the evaluation target cost logic in the past is stored. In the example of FIG. 4, a “country” indicating the evaluation target country, a “category” of the service, a “cost item/calculation item (calculation item is described later)”, a “unit”, and a “difference definition” are stored in association with each other.

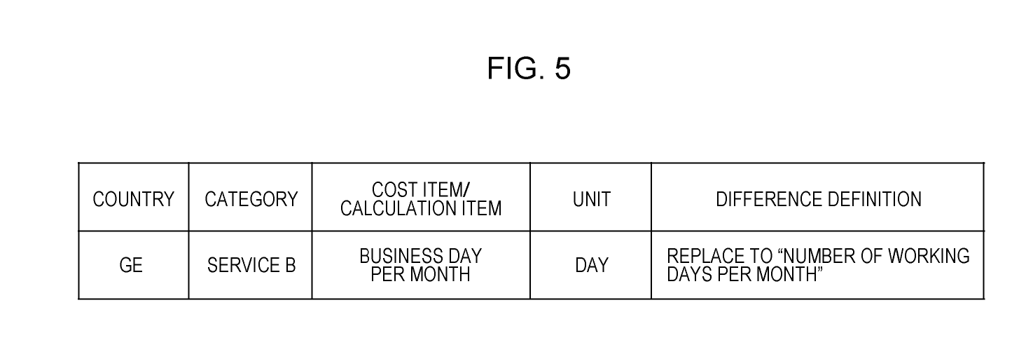

The specification unit 14 extracts the difference definition that has the same “country” or “category” with the evaluation target cost item with content inconsistency and has similar “cost item” and “unit” as a candidate of the difference definition of the evaluation target cost item with content inconsistency of this time. For example, the specification unit 14 extracts the difference definition with the most consistent number of characters with “cost item/calculation item” and “unit” of the difference definition DB 26 and the evaluation target cost item with content inconsistency. The specification unit 14 may extract one or more difference definition with the number of consistent characters equal to or more than a predetermined number. The specification unit 14, for example, as illustrated in FIG. 5, presents the extracted difference definition as a candidate of the difference definition of the evaluation target cost item with content inconsistency of this time in a manner selectable by the user.

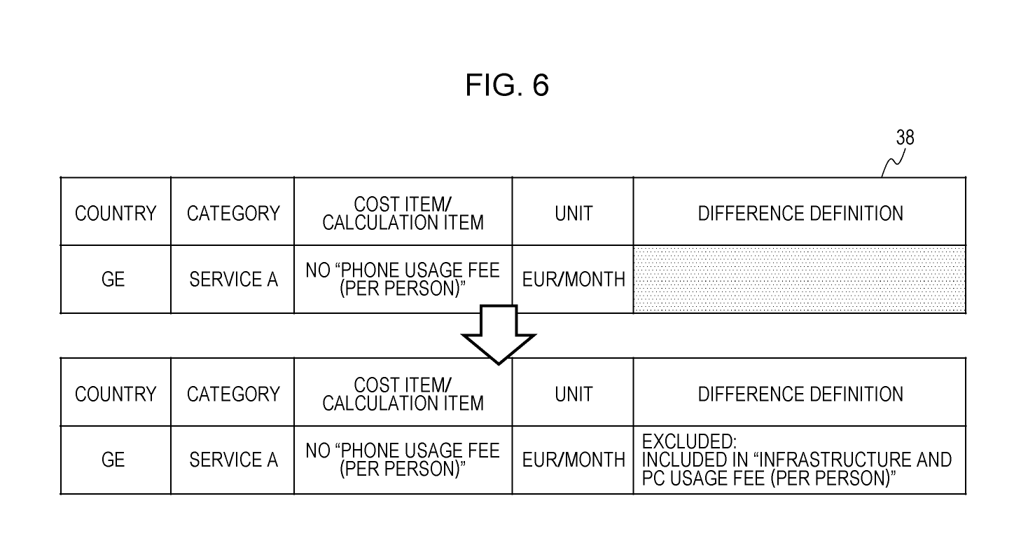

Moreover, in a case where there is no candidate of the difference definition to be presented, or in a case where none of the candidates are selected from the presented candidates of the difference definition, the specification unit 14, for example, presents an input screen 38 for manually receiving the difference definition as illustrated in the upper part of FIG. 6. As illustrated in the lower part of FIG. 6, the specification unit 14 receives the difference definition from the user via the input screen 38. The example of FIG. 6 is a provisional evaluation target cost item with content inconsistency created as an evaluation target cost item indicating that there is no “cost item” of the standard cost item in the evaluation target cost item. In this case, in a case where the evaluation target cost item and the standard cost item are synonymous by adding a “cost item” in association with the standard cost item, the fact is received as a “difference definition”. Moreover, in a case where the evaluation target cost item and the standard cost item are synonymous even if there is no corresponding “cost item” as the evaluation target cost item, such reasons and information on related cost items, calculation expressions, and the like are received as a “difference definition”.

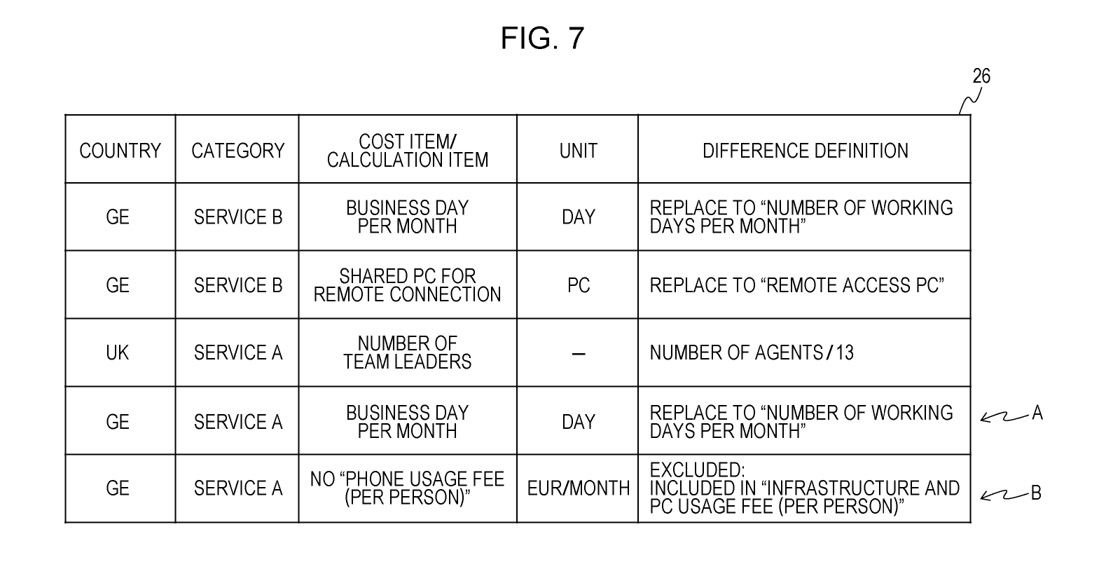

As illustrated in FIG. 7, the specification unit 14 stores the selected difference definition or the received difference definition, the service category and the evaluation target country of this time, and the evaluation target cost item with content inconsistency in association with each other in the difference definition DB 26. In a case where the difference definition stored in the difference definition DB 26 is reflected, the specification unit 14 repeats processing of specifying the difference definition on the evaluation target cost item with content inconsistency until there is no evaluation target cost item with content inconsistency.

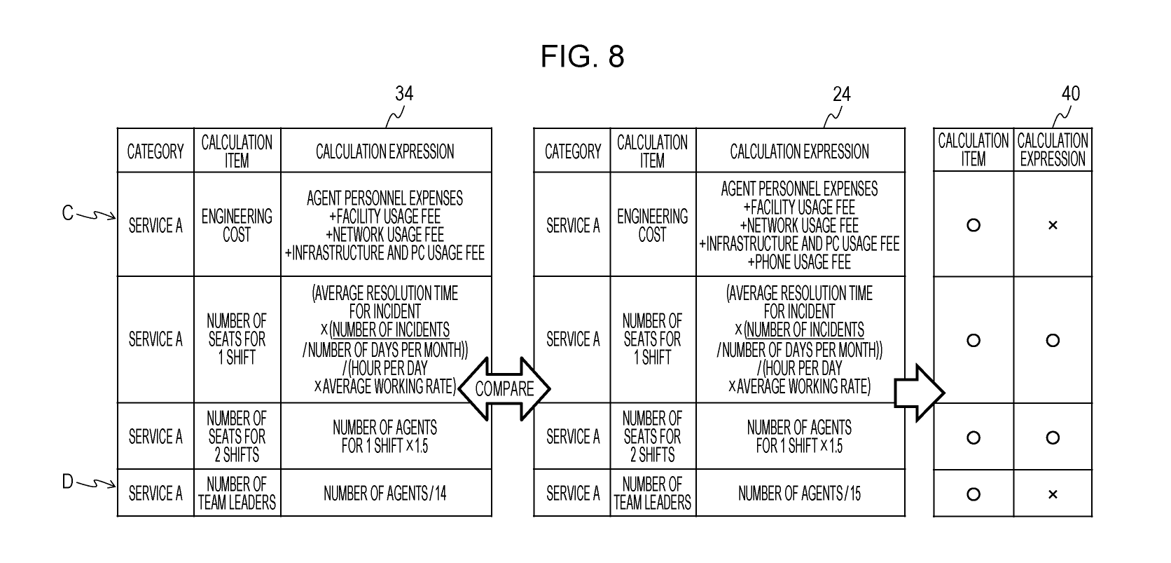

The comparison unit 16 compares the evaluation target calculation expression with the standard calculation expression when there is no evaluation target cost item with content inconsistency. Specifically, the comparison unit 16 extracts the standard calculation expression in association with the same category with the evaluation target calculation expression from the calculation expression DB 24, and associates each evaluation target calculation expression with each extracted standard calculation expression on a one-to-one basis. The comparison unit 16 compares whether or not the evaluation target calculation expression matches the standard calculation expression. Whether or not the evaluation target calculation expression matches the standard calculation expression may be determined based on degree of consistency of character strings and whether or not the evaluation target calculation expression and the standard calculation expression are synonymous may be determined based on the combination of an operator and the cost item included in the calculation expression. The comparison unit 16 extracts the evaluation target calculation expression that does not match the standard calculation expression. An example of a comparison result 40 of the evaluation target calculation expression and the standard calculation expression is illustrated in FIG. 8.

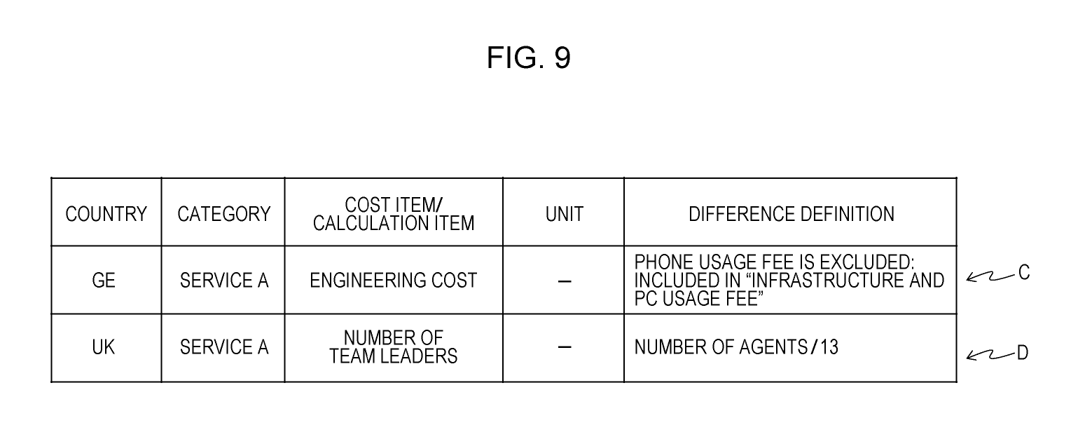

The comparison unit 16 presents a candidate of difference definition to the user for the evaluation target calculation expression not matching with the standard calculation expression similar to the case of the evaluation target cost item with content inconsistency. Specifically, the comparison unit 16 extracts the difference definition that has the same “country” or “category” of the difference definition DB 26 with the evaluation target cost logic and the “cost item/calculation item” is consistent with the “calculation item” in the evaluation target calculation expression that does not match the standard calculation expression. The comparison unit 16, for example, as illustrated in FIG. 9, presents the extracted difference definition as a candidate of the difference definition of the evaluation target calculation expression that does not match the standard calculation expression in a manner selectable by the user.

The comparison unit 16 extracts the difference definition that has the same “country” or “category” of the difference definition DB 26 with the evaluation target cost logic and the “cost item/calculation item” is consistent with the cost item of which the evaluation target calculation expression that does not match the standard calculation expression and the standard calculation expression are inconsistent. In this case, the comparison unit 16 defines a “cost item/calculation item” field of the difference definition as the calculation item of the evaluation target calculation expression that does not match the standard calculation expression and presents the difference definition as a candidate added with the inconsistent cost item (“phone usage fee” in the case of the record of the first row in FIG. 9) in a “difference definition” field.

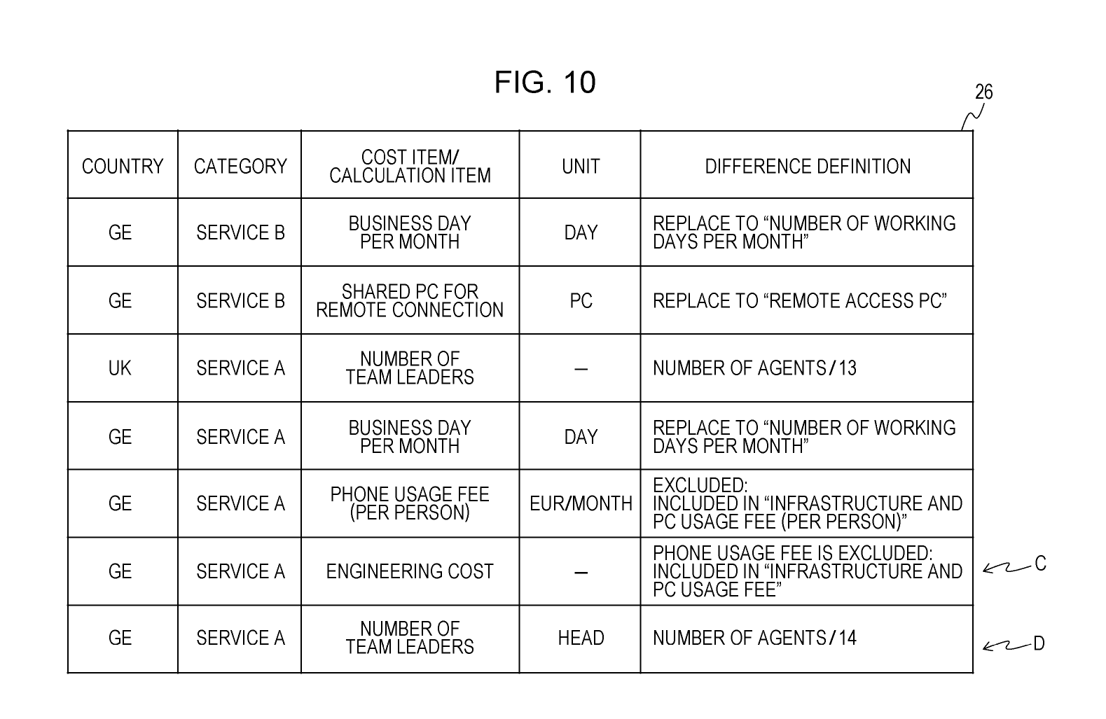

Similar to the case of the above-described evaluation target cost item with content inconsistency, the comparison unit 16 presents an input screen in a case where there is no candidate of the difference definition to be presented or in a case where none of the candidates of the difference definition to be presented is selected to receive a difference definition from the user. The comparison unit 16, as illustrated in FIG. 10, stores the selected difference definition or the difference definition received from the input screen in the difference definition DB 26.

The comparison unit 16 compares the evaluation target calculation expression that does not match the standard calculation expression again after reflecting the difference definition stored in the difference definition DB 26, and updates the comparison result 40. For the calculation expression, since the evaluation target calculation expression may not be strictly matched with the standard calculation expression as the case of the cost item and the unit, inconsistency may remain between the evaluation target calculation expression and the standard calculation expression.

The output unit 18 outputs the evaluation result 42 comparing the cost calculated by the evaluation target cost logic 30 and the cost calculated by the standard cost logic. Specifically, the output unit 18 calculates the cost by substituting a “value” of the cost item definition DBs 32 and 22 in each cost item included in the calculation expression for each of the evaluation target cost logic 30 and the standard cost logic. At this time, the output unit 18 calculates the cost converted into currency defined as a “unit” in the standard cost item for the evaluation target calculation expression including the evaluation target cost item with currency inconsistency extracted by the specification unit 14 with reference to an exchange rate DB (not illustrated). The exchange rate DB may be stored in a predetermined storage region of the evaluation apparatus 10, and may be acquired by accessing external information.

The output unit 18 substitutes values in random for the cost item that the “value” of the cost item definition DBs 32 and 22 is a “variable parameter”. The output unit 18 calculates the cost for each combination of values of a plurality of patterns (for example, 100 patterns) by changing the values substituted in random. The output unit 18 calculates the average cost of the plurality of patterns calculated for each of the evaluation target cost logic 30 and the standard cost logic, and stores the evaluation indicating whether or not the average difference in cost is within the a predetermined range in the evaluation result 42. For example, in a case where the average difference in cost is equal to or less than a predetermined ratio (for example, 5% or less) of the average cost of the standard cost logic, it is possible to set the evaluation (for example, “OK”) indicating that the evaluation target cost logic may be unified with the standard cost logic. In a case where the average difference in cost exceeds the predetermined ratio of the average cost of the standard cost logic, it is possible to set the evaluation (for example, “NG”) indicating that it is difficult to unify the evaluation target cost logic with the standard cost logic.

The output unit 18 calculates difference between the maximum and the minimum cost of the calculated plurality of patterns for the evaluation target cost logic 30. The output unit 18 may add a value substituted in a cost item of a variable parameter and the cost item thereof or a calculation expression that includes the cost item thereof to the evaluation result 42 in the pattern having the maximum cost or the minimum cost in a case where the cost difference exceeds the predetermined range. According to the information, it is possible to grasp the condition (value) in which an irregular cost is calculated.

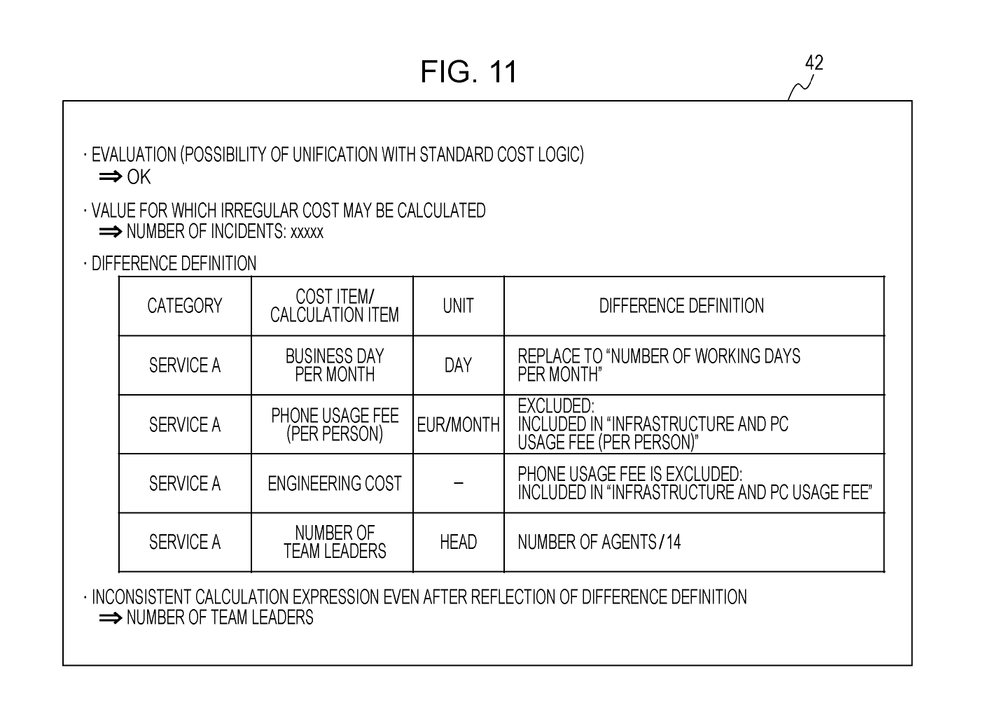

The output unit 18 may add the stored difference definition in the difference definition DB 26 to the evaluation result 42 for the evaluation target cost logic 30 of this time. The output unit 18, for example, as illustrated in FIG. 11, outputs the evaluation result 42 storing the above-described evaluation and various information.

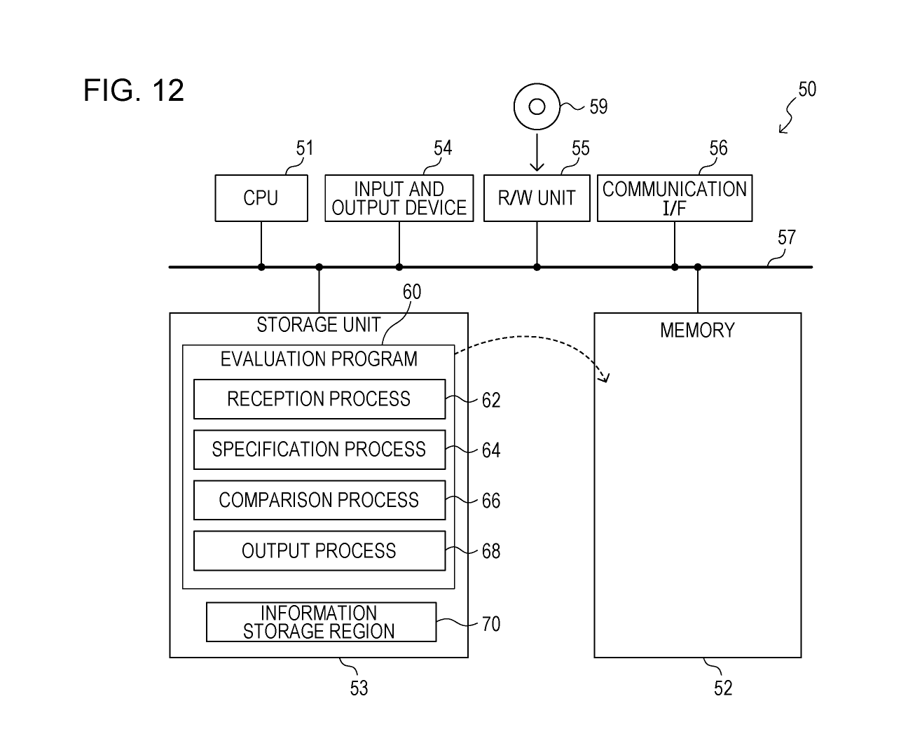

The evaluation apparatus 10 may be realized with a computer 50 illustrated in FIG. 12, for example. The computer 50 is provided with a central processing unit (CPU) 51, a memory 52 as a temporary storage region, and a non-volatile storage unit 53. Moreover, the computer 50 is provided with an input and output device 54 such as an input device and a display device, a read and write (R/W) unit 55 that controls reading and writing of data on a storage medium 59, and a communication interface (I/F) 56 connected to a network such as Internet. The CPU 51, the memory 52, the storage unit 53, the input and output device 54, the R/W unit 55, and the communication I/F 56 are connected to each other via a bus 57.

The storage unit 53 may be realized by a hard disk drive (HDD), a solid state drive (SSD), a flash memory, and the like. In the storage unit 53 as a storage medium, an evaluation program 60 for causing the computer 50 to function as the evaluation apparatus 10 is stored. The evaluation program 60 includes a reception process 62, a specification process 64, a comparison process 66, and an output process 68. Moreover, the storage unit 53 includes the cost item definition DB 22, the calculation expression DB 24, and an information storage region 70 for storing information that constitutes each of difference definition DB 26.

The CPU 51 reads the evaluation program 60 from the storage unit 53, develops the evaluation program 60 in the memory 52, and sequentially executes the processes included in the evaluation program 60. The CPU 51 operates as the reception unit 12 illustrated in FIG. 1 by executing the reception process 62. The CPU 51 operates as the specification unit 14 illustrated in FIG. 1 by executing the specification process 64. The CPU 51 operates as the comparison unit 16 illustrated in FIG. 1 by executing the comparison process 66. The CPU 51 operates as the output unit 18 illustrated in FIG. 1 by executing the output process 68. The CPU 51 reads information from the information storage region 70 and develops each of the cost item definition DB 22, the calculation expression DB 24, and the difference definition DB 26 in the memory 52. Accordingly, the computer 50 that executed the evaluation program 60 functions as the evaluation apparatus 10. The CPU 51 that executes the program is hardware.

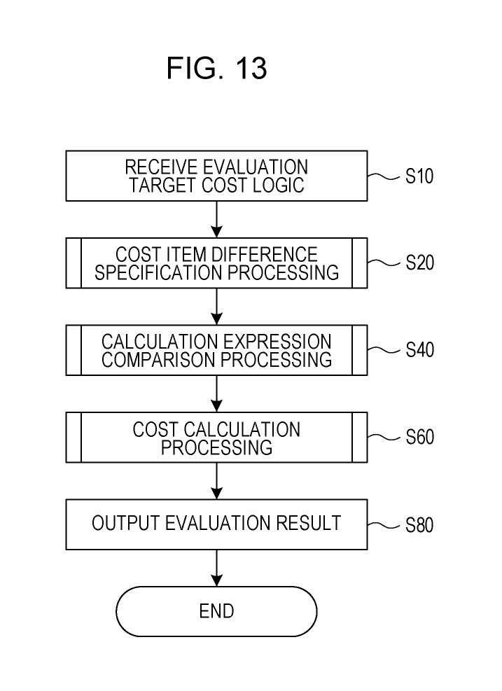

Next, the operation of the evaluation apparatus 10 according to the present embodiment will be explained. When the evaluation target cost logic 30 is input in the evaluation apparatus 10, and execution of the evaluation comparing with the standard cost logic is instructed, an evaluation processing illustrated in FIG. 13 will be executed in the evaluation apparatus 10. Here, assume that the evaluation target cost logic 30 illustrated in FIG. 2 is input.

In operation S10, the reception unit 12 receives the evaluation target cost logic 30 input in the evaluation apparatus 10, and transfers the received evaluation target cost logic 30 to the specification unit 14.

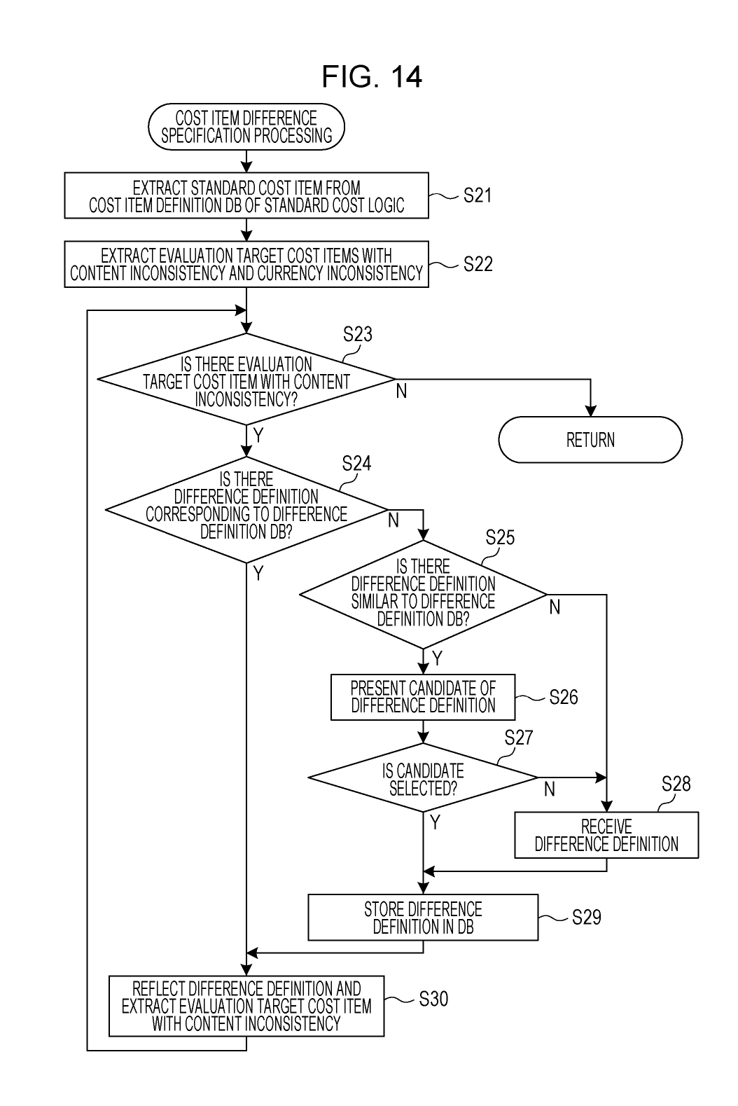

Next, in operation S20, the specification unit 14 executes cost item difference specification processing illustrated in FIG. 14.

In operation S21 of the cost item difference specification processing illustrated in FIG. 14, the specification unit 14 extracts the standard cost item associated with the same category (“service A” in here) with the evaluation target cost item from the cost item definition DB 22.

Next, in operation S22, the specification unit 14 compares each evaluation target cost item with each extracted standard cost item, and extracts evaluation target cost item with content inconsistency or currency inconsistency.

For example, the specification unit 14 compares each of the standard cost item with character strings using all the combinations for each of the evaluation target cost items, and pairs the evaluation target cost item other with the standard cost item the “cost item” and the “unit” are perfectly consistent with each. The comparison unit 16 pairs each remaining evaluation target cost item which are not paired with the standard cost item that the “cost item” is perfectly consistent. The specification unit 14 further pairs each of remaining evaluation target cost item in a descending order of similarity (for example, number of consistent characters) when comparing the standard cost item and the character string.

In FIG. 3, it is illustrated that the cost item definition DB 32 of the evaluation target cost logic 30 and the cost item definition DB 22 of the standard cost logic such that the pair of evaluation target cost item and standard cost item to be in the same row. B in FIG. 3 is an example of a provisionally created evaluation target cost item indicating that the “cost item” of the standard cost item is not in the evaluation target cost item for the standard cost item that has no evaluation target cost item to be paired.

The specification unit 14 compares the character strings of the pair of the evaluation target cost item and the standard cost item and determines whether or not the content (“cost item” or “unit” defined other than a currency is inconsistent) is inconsistent or the currency (currency defined in “unit” in currency) is inconsistent to create the comparison result 36 as illustrated in FIG. 3. Whether or not the currency is inconsistent may be determined by predetermining a character string that indicates a currency and checking whether or not the character string is inconsistent in a case where the character string indicating a currency is included in the “unit”. The specification unit 14 extracts the evaluation target cost item with content inconsistency and the evaluation target cost item with currency inconsistency from the cost item definition DB 32 with reference to the comparison result 36.

Next, in operation S23, the specification unit 14 determines whether or not there is the evaluation target cost item with content inconsistency. In a case where there is the evaluation target cost item with content inconsistency, the specification unit 14 executes following operations S24 to S29 for each extracted evaluation target cost item with content inconsistency.

In operation S24, the specification unit 14 searches the difference definition that the “country”, the “category”, the “cost item”, and the “unit” are consistent with the evaluation target cost item with content inconsistency from the difference definition DB 26. In a case where there is a corresponding difference definition, the processing proceeds to operation S30, and in a case where there is no corresponding difference definition, the processing proceeds to operation S25.

In operation S25, the specification unit 14 searches the difference definition that has the same “country” or “category” with the evaluation target cost item with content inconsistency and has the similar “cost item” and “unit” from the difference definition DB 26. In a case where there is a similar difference definition, the processing proceeds to operation S26, and in a case where there is no similar difference definition, the processing will proceed to operation S28.

In operation S26, the specification unit 14 extracts the searched difference definition as a candidate of the difference definition of the evaluation target cost item with content inconsistency and presents the searched difference definition in a manner selectable by the user. For example, as illustrated in FIG. 4, in a case where the difference definition is stored in the difference definition DB 26, a candidate of the difference definition illustrated in FIG. 5 is presented for the evaluation target cost item with content inconsistency illustrated in A of FIG. 3.

In a case where the presented candidate of the difference definition is reflected to the evaluation target cost item with content inconsistency, the user selects the corresponding candidate in a case where the presented candidate is determined to be synonymous with the pairing standard cost item, and selects a command not selecting the candidate in a case where the presented candidate is determined not to be synonymous with the pairing standard cost item.

Next, in operation S27, the specification unit 14 determines whether or not the presented candidate of the difference definition is selected. In a case where the candidate is selected, the processing proceeds to operation S29, and in a case where the candidate is not selected, the processing proceeds to operation S28.

In operation S28, the specification unit 14, for example, as illustrated in FIG. 6, presents the input screen 38 for manually receiving the difference definition, and receives the difference definition from the user. The example of FIG. 6 is an example that the difference definition and the input screen 38 are received in a case where there is no presented candidate of the difference definition for the evaluation target cost item with content inconsistency illustrated in B of FIG. 3.

Next, in operation S29, the specification unit 14 stores the difference definition selected from the presented candidate of the difference definition or the difference definition received via the input screen 38 in the difference definition DB 26.

Next, in operation S30, the specification unit 14 determines whether or not the inconsistency is resolved by comparing the evaluation target cost item with content inconsistency after reflecting the difference definition with the pairing standard cost item. For example, assume that the difference definition illustrated in A of FIG. 7 is specified for the evaluation target cost item with content inconsistency illustrated in A of FIG. 3. In this case, the inconsistency with the pairing standard cost item is resolved by replacing “business day per month” of “cost item” of the evaluation target cost item illustrated in A of FIG. 3 to “working day per month”. For example, assume that the difference definition illustrated in B of FIG. 7 is specified for the evaluation target cost item with content inconsistency illustrated in B of FIG. 3. In this case, since “phone usage fee” of the cost item is included in another cost item, the difference definition represents that “phone usage fee” may be excluded. The “phone usage fee” is excluded in a comparison with the pared standard cost item and the inconsistency is resolved. The specification unit 14 extracts the evaluation target cost item in which the inconsistency is not resolved as the evaluation target cost item with content inconsistency, and the processing returns to operation S23.

In operation S30, in a case where the evaluation target cost item with content inconsistency is not extracted, a negative determination is made in operation S23, and the processing returns to the evaluation processing (FIG. 13).

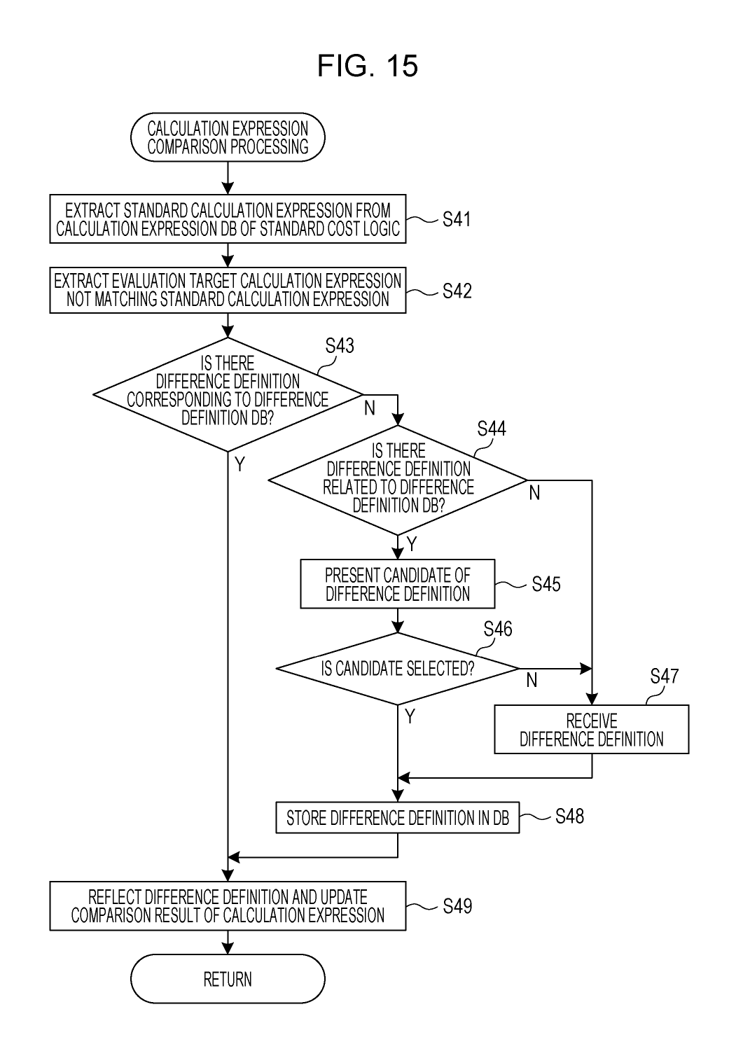

Next, in operation S40 of the evaluation processing, the comparison unit 16 executes the calculation expression comparison processing illustrated in FIG. 15.

In operation S41 of the calculation expression comparison processing illustrated in FIG. 15, the comparison unit 16 extracts a standard calculation expression associated with the same category (“service A” in here) with the evaluation target cost item from the cost item definition DB 22.

Next, in operation S42, the comparison unit 16 compares each of extracted standard calculation expression with each of evaluation target calculation expression on a one-to-one basis. The comparison unit 16 extracts the standard calculation expression that does not match the evaluation target calculation expression, and executes the following processing of operations S43 to S49 for each extracted evaluation target calculation expression.

In operation S43, the comparison unit 16 searches the difference definition that the “country”, the “category”, and the “calculation item” are consistent with the evaluation target calculation expression not matching with the standard calculation expression from the difference definition DB 26. In a case where there is a corresponding difference definition, the processing proceeds to operation S49, and in a case where there is no corresponding difference definition, the processing proceeds to operation S44.

In operation S44, the comparison unit 16 searches the difference definition related to the evaluation target calculation expression not matching with the standard calculation expression from the difference definition DB 26. Specifically, the comparison unit 16 searches the difference definition that has the same “country” or “category” with the evaluation target calculation expression and the “cost item/calculation item” is consistent with the “calculation item” in the evaluation target calculation expression. Moreover, the comparison unit 16 searches the difference definition that has the same “country” or “category” of the difference definition DB 26 with the evaluation target calculation expression and the “cost item/calculation item” is consistent with the cost item of which the evaluation target calculation expression that does not match the standard calculation expression and the standard calculation expression are inconsistent. In a case where there is a related difference definition, the processing proceeds to operation S45 and in a case where there is no related difference definition, the processing proceeds to operation S47.

In operation S45, the searched related difference definition is extracted as a candidate of difference definition of the evaluation target calculation expression that does not match the standard calculation expression and is presented in a manner selectable by the user. For example, the cost item “phone usage fee” included in the pairing standard calculation expression is not included in the evaluation target calculation expression illustrated in C of FIG. 8. Therefore, for example, the difference definition in which the “cost item” is “no phone usage fee” is extracted from the difference definition DB 26 illustrated in FIG. 7 and is presented as a candidate, as illustrated in C of FIG. 9. For the evaluation target calculation expression illustrated in D of FIG. 8, since there is a difference definition having different “country” and the same “category” and “calculation item” in the difference definition DB 26, the difference definition, as illustrated in D of FIG. 9, is presented as a candidate.

Next, in operation S46, the comparison unit 16 determines whether or not the presented candidate of the difference definition is selected. In a case where the candidate is selected, the processing proceeds to operation S48, and in a case where the candidate is not selected, the processing proceeds to operation S47.

In operation S47, the comparison unit 16 presents the input screen 38 for manually receiving the difference definition similar to the case of the evaluation target cost item with content inconsistency, and receives the difference definition from the user.

Next, in operation S49, the comparison unit 16 stores the difference definition selected from the presented candidate of difference definition or the difference definition received via the input screen 38 in the difference definition DB 26. For example, the difference definition illustrated in C of FIG. 10 is the specified difference definition selected from the candidate presented in C of FIG. 9. The difference definition illustrated in D of FIG. 10 is the specified difference definition that the presented candidate is not selected as illustrated in D of FIG. 9 and is received via the input screen 38.

Next, in operation S49, the comparison unit 16 reflects the difference definition that the “country”, the “category”, and the “calculation item” are consistent among the difference definitions stored in the difference definition DB 26 to the evaluation target calculation expression that does not match the standard calculation expression. The comparison unit 16 compares the evaluation target calculation expression after reflecting the difference definition with the standard calculation expression again, and updates the comparison result 40. For example, in the evaluation target calculation expression illustrated in C of FIG. 8, the “phone usage fee” included in the pairing standard calculation expression is not included. However, by reflecting the difference definition illustrated in C of FIG. 10, the “phone usage fee” of the standard calculation expression is excluded from the target, and thereby the inconsistency is resolved. In the case of evaluation target calculation expression illustrated in D of FIG. 8, even if the difference definition illustrated in D of FIG. 10 is reflected, the evaluation target calculation expression and the standard calculation expression are inconsistent, and thereby the inconsistency remains. When the present operation ends, the processing returns to the evaluation processing (FIG. 13).

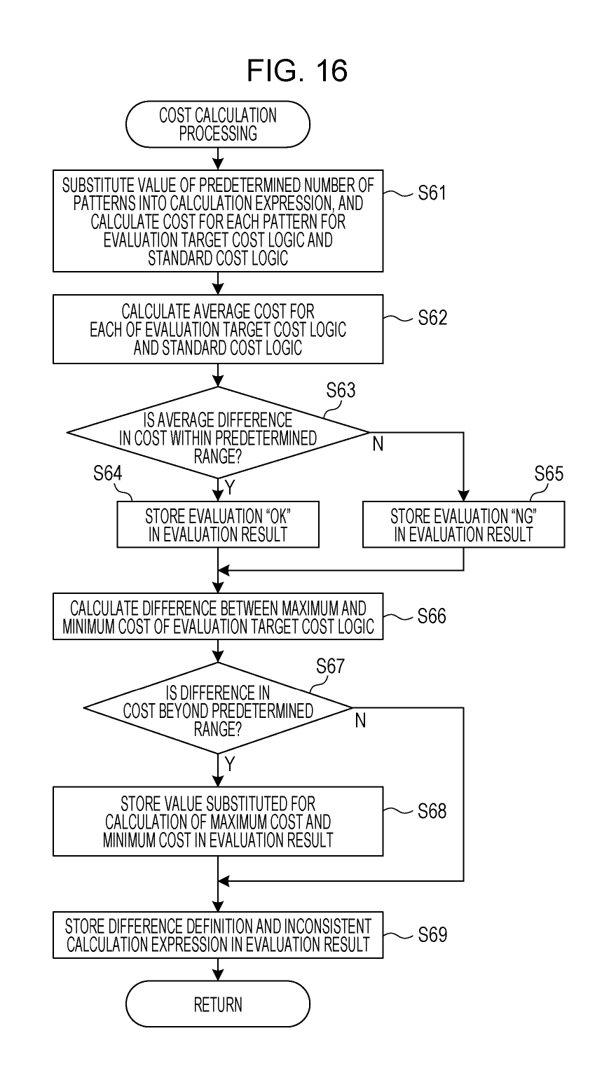

In operation S60 of the evaluation processing, the output unit 18 executes the cost calculation processing illustrated in FIG. 16.

In operation S61 of the cost calculation processing illustrated in FIG. 16, the output unit 18 calculates the cost by substituting the “value” of the cost item definition DBs 32 and 22 in each cost item included in the calculation expressions for each of the evaluation target cost logic 30 and the standard cost logic. At this time, the output unit 18 calculates the cost converted in to currency defined as “unit” in the standard cost item with reference to the exchange rate DB (not illustrated) for the evaluation target calculation expression including the evaluation target cost item with currency inconsistency extracted by the specification unit 14. The output unit 18 calculates the cost for each combination of values of a plurality of patterns (for example, 100 patterns) by substituting the values in random for the cost item in which the “value” of the cost item definition DBs 32 and 22 is a “variable parameter”.

Next, in operation S62, the output unit 18 calculates average cost of the plurality of patterns calculated for each of the evaluation target cost logic 30 and the standard cost logic. Next, in operation S63, the output unit 18 determines whether or not the average difference in cost between the evaluation target cost logic 30 and the standard cost logic is within the predetermined range. In a case where the average difference in cost is within the predetermined range, the processing proceeds to operation S64 and in a case where the average difference in cost exceeds the predetermined range, the processing proceeds to operation S65.

In operation S64, the output unit 18 stores the evaluation (for example, “OK”) indicating that the evaluation target cost logic 30 may be unified with the standard cost logic in the evaluation result 42. On the other hand, in operation S65, the output unit 18 stores the evaluation (for example, “NG”) indicating that it is difficult to unify the evaluation target cost logic 30 with the standard cost logic in the evaluation result 42.

Next, in operation S66, the output unit 18 calculates the difference between the maximum cost and the minimum cost of the calculated plurality of patterns for the evaluation target cost logic 30. Next, in operation S67, the output unit 18 determines whether or not the difference between the maximum cost and the minimum cost exceeds the predetermined range. In a case where the difference in cost exceeds the predetermined range, the processing proceeds to operation S68, and in a case where the difference in cost is within the predetermined range, the processing proceeds to operation S69.

In operation S68, in patterns having the maximum cost and the minimum cost, the value substituted in the cost item of the variable parameter and the calculation expression including the cost item or the cost item may be stored in the evaluation result 42.

Next, in operation S69, the output unit 18 extracts the difference definition that the “country” is an evaluation target country (“DE” in here) and the “category” is a service category (“service A” in here) of the evaluation target cost logic 30 from the difference definition DB 26, and stores in the evaluation result 42. The output unit 18 extracts the evaluation target calculation expression that does not match the standard calculation expression even after the difference definition is reflected with reference to the comparison result 40 updated in operation S49 of the calculation expression comparison processing (FIG. 15), and stores in the evaluation result 42. The processing returns to the evaluation processing (FIG. 13).

In operation S80 of the evaluation processing, the output unit 18, for example, as illustrated in FIG. 11, outputs the evaluation result 42 storing evaluation and various information, and ends the evaluation processing.

As described above, the evaluation apparatus 10 according to the present embodiment first specifies the difference to make the cost item consistent between the cost logics when comparing the cost item included in the calculation expression with the cost logic defined by the unit and the calculation expression corresponding to the cost item. The calculation expressions are compared after the difference is reflected. In a case where the cost item is not consistent, there are cases that an equivalent cost is accidentally calculated even if there is a possibility that the calculation expressions including the cost item may not be synonymous. In this case, it is hard to say that the cost logic is compared properly. According to the evaluation apparatus 10 according to the present embodiment, it possible to properly and easily perform the evaluation related to the unification of the cost logic for calculating cost.

As the difference definition is accumulated in the difference definition DB, it is possible to present candidates highly likely to be selected as the difference definition, and a manual input of the difference definition reduces, and thereby it is possible to shorten the evaluation time.

In the above-described embodiment, a case of outputting four types of information illustrated in FIG. 11 as an evaluation result is explained but it is not limited to the case of outputting all the pieces of information. Only one piece of information may be used as the evaluation result, and two or more pieces of information may be used as the evaluation result. Moreover, other information such as an exchange rate used for exchanging the currency and an evaluation target cost item with currency inconsistency may be added to the evaluation result.

In the above-described embodiment, the mode in which the evaluation program 60 is already stored (installed) in the storage unit 53 is described but not limited to this. The program according to the embodiment may be provided in a mode stored in a storage medium such as a CD-ROM, a DVD-ROM, and a USB memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An evaluation device comprising:
a memory; and
a processor coupled to the memory and the processor configured to:
receive an evaluation target cost logic for a cost logic defined with a calculation expression that calculates a cost of a service and a record including a combination of an item used in the calculation expression and a unit corresponding to the item;
refer to a standard cost logic stored in the memory in advance for each type of service;
specify a difference for matching a first record of the evaluation target cost logic with a second record of the standard cost logic, the first record and the second record being for a same type of service;
reflect the specified difference to the first record; and
compare a first calculation expression of the evaluation target cost logic using the first record and a second calculation expression of the standard cost logic using the second record.

2. The evaluation device according to claim 1,
wherein the processor is configured to
present the first record that does not match the second record to a user, and
receive the difference from the user.

3. The evaluation device according to claim 2,
wherein the difference specified is previously stored in the memory, and
wherein, when the first record that does not match the second record is presented to the user, the processor is configured to acquire the difference related to the first record from the memory, and present the first record in a manner selectable by the user.

4. The evaluation device according to claim 1,
wherein the processor is further configured to:
output, as an evaluation result of the evaluation target cost logic with respect to the standard cost logic, at least one of
the specified difference,
an average difference in costs of a plurality of patterns calculated by substituting values in random in an item with a variable value in a calculation expression in each of the evaluation target cost logic and the standard cost logic,
a value substituted in the variable value in each pattern having a maximum cost and a minimum cost in a case where a difference between the maximum cost and the minimum cost of the plurality of patterns calculated for the evaluation target cost logic is equal to or larger than a predetermined value, and
the first calculation expression that does not match the second calculation expression in a case where the specified difference is reflected to the first record.

5. A computer-implemented evaluation method comprising:
receiving an evaluation target cost logic for a cost logic defined with a calculation expression that calculates a cost of a service and a record including a combination of an item used in the calculation expression and a unit corresponding to the item;
referring to a standard cost logic stored in a memory in advance for each type of service;
specify a difference for matching a first record of the evaluation target cost logic with a second record of the standard cost logic, the first record and the second record being for a same type of service;
reflecting the specified difference to the first record; and
comparing a first calculation expression of the evaluation target cost logic using the first record and a second calculation expression of the standard cost logic using the second record, by a processor.

6. The computer-implemented evaluation method according to claim 5,
wherein the processor presents the first record that does not match the second record to a user, and receives the difference from the user.

7. The computer-implemented evaluation method according to claim 6,
wherein the difference specified is previously stored in the memory, and
wherein, when the first record that does not match the second record is presented to the user, the processor acquires the difference related to the first record from the memory, and presents the first record in a manner selectable by the user.

8. The computer-implemented evaluation method according to claim 5,
wherein the processor outputs, as an evaluation result of the evaluation target cost logic with respect to the standard cost logic, at least one of
the specified difference,
an average difference in costs of a plurality of patterns calculated by substituting values in random in an item with a variable value in a calculation expression in each of the evaluation target cost logic and the standard cost logic,
a value substituted in the variable value in each pattern having a maximum cost and a minimum cost in a case where a difference between the maximum cost and the minimum cost of the plurality of patterns calculated for the evaluation target cost logic is equal to or larger than a predetermined value, and
the first calculation expression that does not match the second calculation expression in a case where the specified difference is reflected to the first record.

9. A non-transitory computer-readable medium storing executable instructions, which when executed by a computer, cause the computer to perform a process comprising:
receiving a target cost logic;
comparing the target cost logic with a standard cost logic stored in a memory, the target cost logic including a plurality of first records and the standard cost logic including a plurality of second records;
extracting a first record from the target cost logic that is determined inconsistent with a second record of the standard cost logic based on the comparing, the first record and the second record relating to a same service;
presenting, via a graphic user interface, an input screen for receiving an input for the first record;
modifying the first record according to the input received via the graphical user interface;
calculating the cost of the target cost logic based on the modified first record; and
outputting an evaluation result based on the calculating.

10. The non-transitory computer-readable medium according to claim 9, wherein the comparing compares first records of the target cost basis and second records of the standard cost logic on a one by one basis.

11. The non-transitory computer-readable medium according to claim 10, wherein the comparing compares the first records and the second records based on a degree of consistency of character strings.

12. The non-transitory computer-readable medium according to claim 9, wherein each of the target cost logic and the standard cost logic include a cost item which is a minimum unit when comparing the target cost logic with the standard cost logic, a unit corresponding to the cost item, and a calculation expression using the cost item and the unit.

13. The non-transitory computer-readable medium according to claim 12, wherein
the presenting presents candidate difference definitions on the graphical user interface that are selectable by the user, the candidate difference definitions are information indicating a difference between the target cost logic and the standard cost logic.
